(19) United States
(12) Patent Application Publication
(10) Pub. No.: US 2018/0144423 A1
(43) Pub. Date: May 24, 2018

(54) SYSTEMS AND METHODOLOGIES FOR COMMUNICATING EDUCATIONAL INFORMATION

(71) Applicant: University of Dammam, Dammam (SA)

(72) Inventors: Amal Yassin H. BALHARITH, Aljubail (SA); Malak Hani A. Alserhani, Aljubail (SA); Hanan Saad E. Aldossary, Aljubail (SA); Fatemah Nahed S. Alsahly, Aljubail (SA)

(73) Assignee: University of Dammam, Dammam (SA)

(21) Appl. No.: 15/359,082

(22) Filed: Nov. 22, 2016

(51) Int. Cl. G06Q 50/20; H04L 12/58; G09B 5/00

(52) U.S. Cl. CPC G06Q 50/205; G06F 17/3053; G09B 5/00; H04L 51/04

(57) ABSTRACT

A system and method for communicating educational information. The method includes providing a school communication platform on a first external device; storing an attribute vector characterizing a student in a first register; storing information associated with one or more guardians of the student acquired via the school communication platform; detecting whether a trigger event associated with the student has occurred based on one or more values of the stored attribute vector; identifying a first guardian from one or more guardians associated with the student as a function of the trigger event and the information associated with the one or more guardians when the trigger event is detected; and outputting a notification to an external device associated with the first guardian when the trigger event is detected. The notification includes information associated with the trigger event when the trigger event is detected.

### BACKGROUND

Schools play an integral part in a child's educational and social development. Often, parents want to be informed about their child's school related issues. Lack of communication between parents and school may lead to a less effective educational environment. In addition, in an emergency such as a fire or severe weather, parents of children enrolled in a school have to be notified.

The foregoing “Background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention.

### SUMMARY

The present disclosure relates to a method for communicating educational information that provides, via processing circuitry of a server, a school communication platform on a first external device. The processing circuitry includes a first register configured to store an attribute vector characterizing a student. The method further stores information associated with one or more guardians of the student acquired via the school communication platform; detects, via the processing circuitry, whether a trigger event associated with the student has occurred based on one or more values of the stored attribute vector; identifies a first guardian from one or more guardians associated with the student as a function of the trigger event and the information associated with the one or more guardians when the trigger event is detected; and outputs a notification to an external device associated with the first guardian when the trigger event is detected. The notification includes information associated with the trigger event when the trigger event is detected.

The foregoing paragraph has been provided by way of general introduction, and is not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a system for communicating educational information according to one example;

FIG. 2 is a block diagram representation of the flow of data and queries between a server and a user device according to one example;

FIG. 3 is a schematic that shows a data structure of the parameters that are used to determine a student ranking according to one example;

FIG. 4 is a flowchart that shows a method for communicating educational information according to one example;

FIG. 5 is a flowchart that shows a method for generating an academic ranking according to one example;

FIG. 6 is a flowchart that shows a method for determining student compliance according to one example;

FIG. 7 is an exemplary log stored by the system according to one example;

FIG. 8 is a schematic that shows a user interface (UI) according to one example;

FIG. 9 is a schematic that shows a login user interface according to one example;

FIG. 10 is a schematic that shows a teacher UI according to one example;

FIG. 11 is a schematic that shows a guardian UI according to one example;

FIG. 12 is a schematic that shows a student UI according to one example;

FIG. 13 is a schematic that shows a student UI according to one example;

FIG. 14 is a schematic that shows an administrator UI according to one example;

FIG. 15 is an exemplary block diagram of the server according to one example;

FIG. 16 is an exemplary block diagram of a data processing system according to one example; and

FIG. 17 is an exemplary block diagram of a central processing unit according to one example.

### DETAILED DESCRIPTION

Referring now to the drawings, wherein like reference numerals designate identical or corresponding parts throughout several views, the following description relates to a system and associated methodology for communicating educational (e.g., school) information. The system provides a communication platform for various parties in an educational system. The system outputs notifications and alerts associated with emergency and non-emergency events to parents and guardians. Further, the system identifies the guardian and the communication method based on the event category.

Parental control is an important tool in establishing a successful school education. The system allows the administration, the students, the teachers, and the parents to integrate in a harmonious way.

Often parents cannot visit the school to communicate with teachers on a regular basis. The system described herein allows communication between parents, students, teachers, and administrators using voice, text, and video messaging to provide school schedule, school announcements, course materials, discussions, and the like. The system includes a plurality of interfaces based on each user privileges and role (e.g., student interface, teacher interface).

Parents can monitor the performance level of a student and communicate with teachers on a permanent basis, enabling them to raise the performance level of the student academically and morally by collaborating with teachers to identify a deficiency in the student's performance and to address it quickly.

A teacher can communicate with the students continuously and update the students' information associated with a certain subject (e.g., duties, discussions, announcements) electronically, which facilitates the educational process. The teacher can increase the level of performance through periodical assessments of the students before the end of the semester. This leads to an increase in the efficiency of teachers.

One or more guardians may be associated with each student. For example, the student may have a primary parent to receive all notifications and alerts and a secondary guardian to receive notifications when the primary parent fails to respond. Users may fail to update the system between the primary and secondary. In addition, updating the primary and secondary parent may cause inconvenience to user. The system 100 automatically determines the available guardian thus increasing the speed in notifying the one or more guardians associated with the student. In addition, a first guardian may be associated with performance notifications and a second guardian may be associated with emergency notifications.

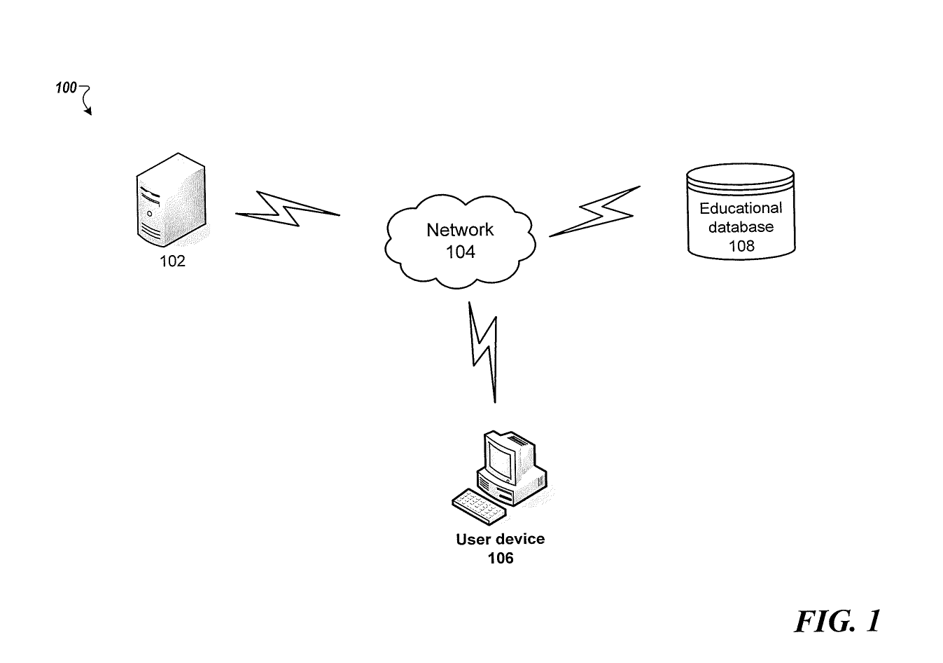

FIG. 1 is a schematic diagram of a system 100 for supporting a school communication platform according to one example. The system 100 includes a server 102, a network 104, a user device 106, and an educational database 108.

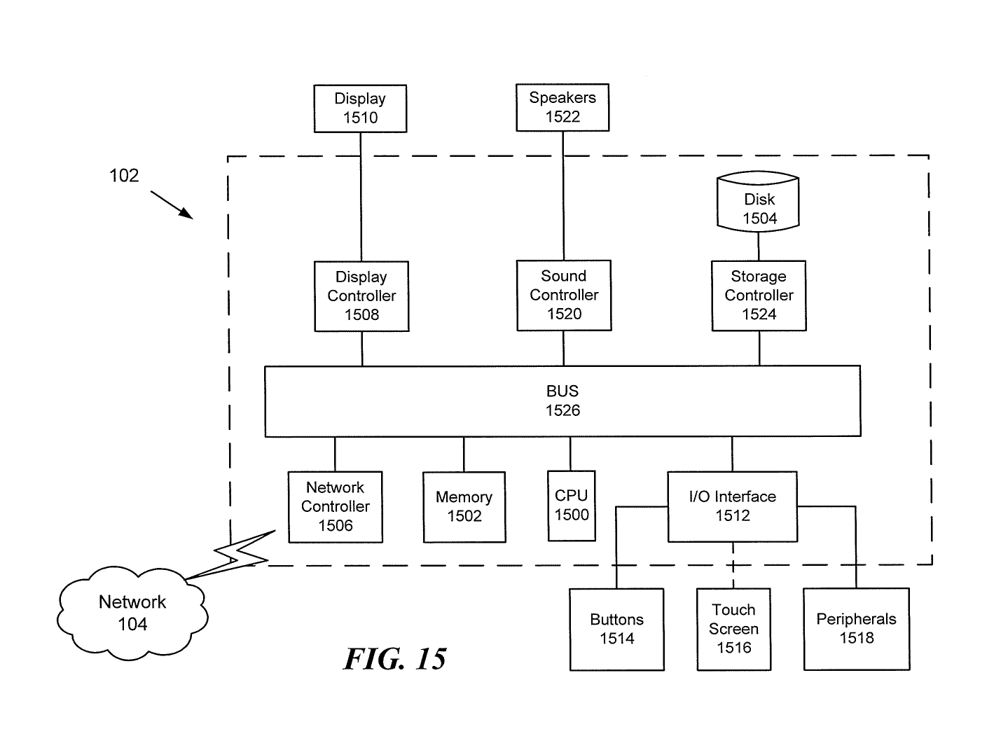

The server 102 can represent one or more servers and is connected to the user device 106 via the network 104. The server 102 may include a CPU 1500 and a memory 1502, as shown in FIG. 15.

The network 104 is any network that allows the server 102 and the user device 106 to communicate information with each other. Suitable networks can include or interface with any one or more of a local intranet, a PAN (Personal Area Network), a LAN (Local Area Network), a WAN (Wide Area Network), a MAN (Metropolitan Area Network), a VPN (Virtual Private Network), or a SAN (storage area network). Furthermore, communications may also include links to any of a variety of wireless networks, including WAP (Wireless Application Protocol), GPRS (General Packet Radio Service), GSM (Global system for Mobile Communication), CDMA (Code Division Multiple Access) or TDMA (Time Division Multiple Access), cellular phone networks, GPS (Global Positioning System), CDPD (Cellular digit packet data), Bluetooth radio, or an IEEE 802.11 based radio frequency.

The user device 106 may include wireless mobile handsets, game consoles, desktop computers, PDA's, pagers, notebook computers, tablets, or other mobile or stationary devices.

The user device 106 can include one or more processors. The user device 106 can represent one or more external devices and can output notifications received from the server 102. The user device 106 can communicate with the server 102 via the network 104 using one or more network interfaces. The user device 106 can include an interface, such as a keyboard and/or a mouse, allowing a user (e.g., student, teacher, guardian) to input parameter data, for example. The parameter data may correspond to the selection of ranking weight, as further described herein. The parameter data can be input by selecting one or more parameters from a list of possible parameters, manually entering the parameters, using voice command, or the like.

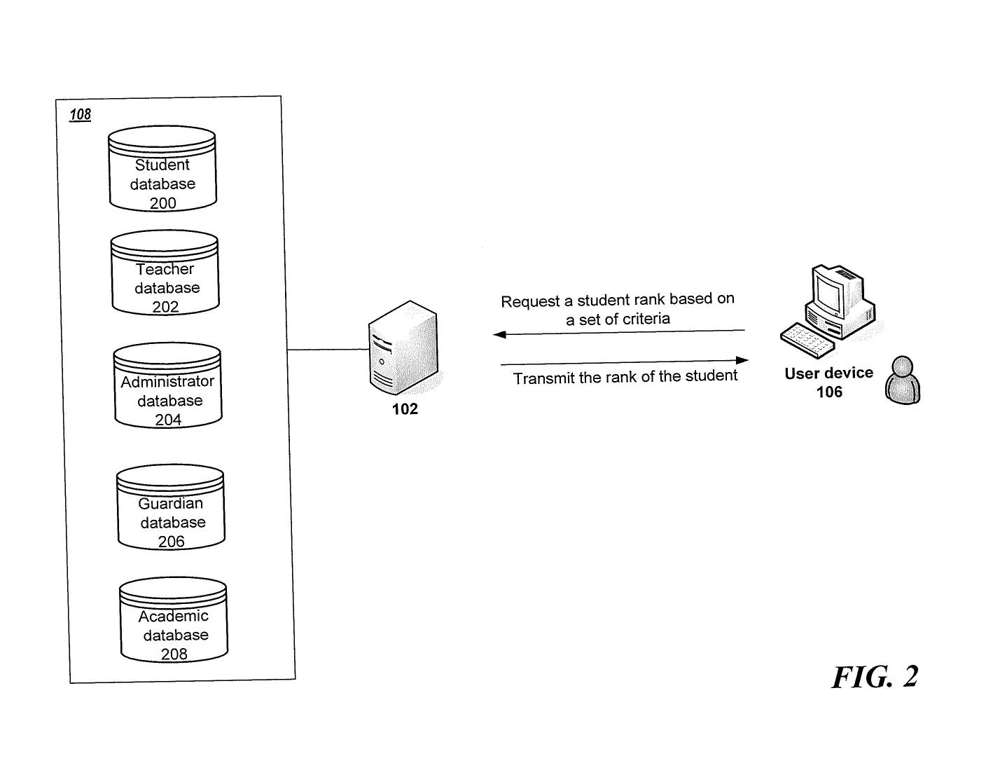

The educational database 108 stores information associated with the students, teachers, guardians, and educational information. The educational database 108 may include one or more databases as shown in FIG. 2. Examples of databases include relational databases such as Microsoft™ SQL server, Oracle™, Sybase™, MySQL™, and the like.

FIG. 2 is a block diagram representation of the flow of data and queries between the server 102 and the user device 106 according to one example. The educational database 108 may include one or more databases. The educational database 108 may include a student database 200, a teacher database 202, an administrator database 204, a guardian database 206, and an academic database 208.

The student database 200 may store student information including class level, student name, student ID, and the like. The student database 200 also stores student logs that may include individualized educational goal for each student and a student progress.

The teacher database 202 stores a teacher profile including a teacher name and teacher ID. In addition, the teacher database 202 stores courses associated with each teacher. The administrator database 204 stores administrators' information including administrator name, ID, access and functions, and the like. An administrator may define a level of access for other users. For example, in an emergency the administrator may authorize access to the student database 200 by emergency responders to retrieve medical and contact information associated with the students. The level of access may be automatically changed when the server 102 detects an emergency, for example, based on information received from the administrator.

The guardian database 206 stores guardian information for each student. Guardian information includes adults that are registered in the system 100 having parental involvement with one or more of the student users in the system 100. The guardian may include, but is not limited to, parents, stepparents, grandparents, uncles/aunts, legal guardians, and the like. The guardian information may include name, contact information, and electronic calendar access information for each authorized guardian. In addition, the guardian database 206 stores a level of access for each guardian associated with the student. For example, one or more guardians may be associated with the student. Each of the guardians may have varied levels of restricted access to the student record. A first guardian may access the student schedule but may be restricted from accessing the student ranking or health information. The academic database 208 stores academic information for each student. The academic information may include grades, progress, assignments, and lecture materials.

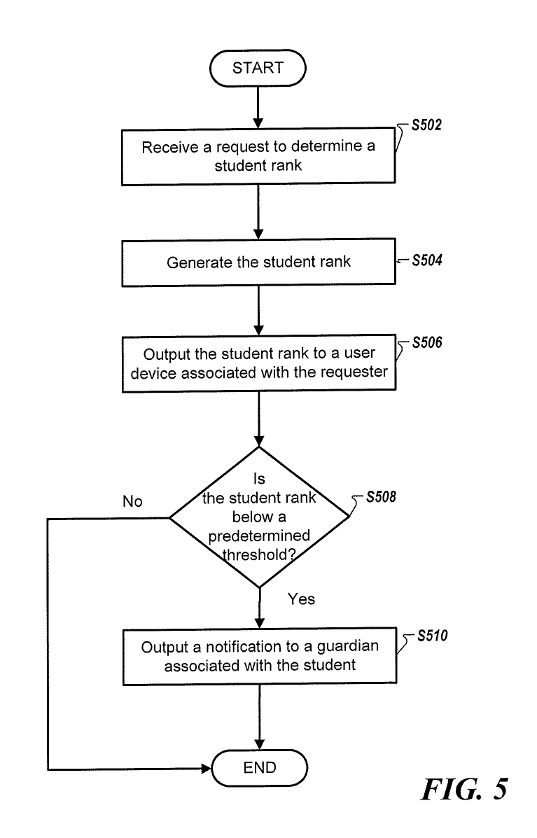

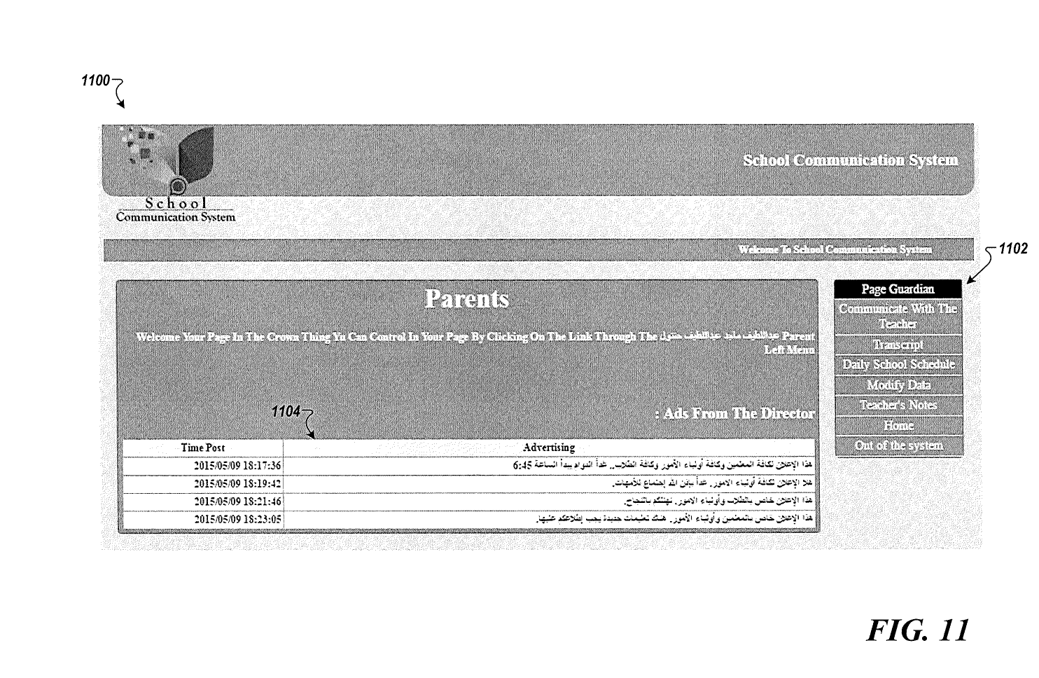

The server 102 may receive a request for a student rank from a user via the user device 106. For example, a guardian may send the request using a guardian interface 1100 shown in FIG. 11. The server 102 may access the guardian database 206 to determine whether the user is authorized to obtain the student rank. Then, the server 102 may access the academic database 208 to obtain data to determine the student rank, for example, using the method described in FIG. 5. The server 102 transmits the ranking information to the user device 106 via the network 104.

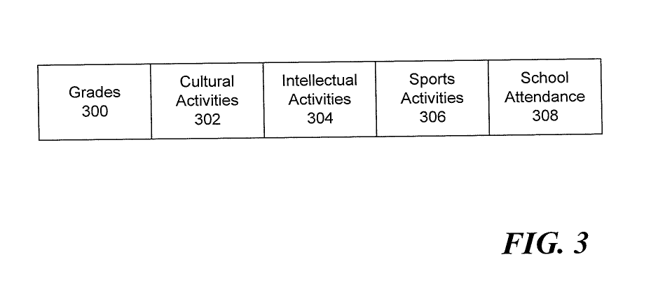

FIG. 3 is a schematic that shows a data structure of the parameters that are used to determine a student ranking according to one example. The parameters may include grades 300 in each subject, cultural activities 302, intellectual activities 304, sports activities 306, and school attendance 308.

Each of the parameters may have a predetermined weight. In addition, the weights may be set by the user requesting the student ranking. Attributes may be mapped to a score (i.e., grade) before determining the student ranking. For example, the number of extracurricular activities (e.g., cultural activities 302, intellectual activities 304, and/or sports activities 306) may be mapped to a score as shown in table 1. While the values are shown to range between 0 and 1, this has been done as a matter of convenience to normalize the impact of each attribute. Other ranges of values may be used as well.

TABLE 1

| Number of | Value |
|---|---|
| extracurricular activities | Range 0 to 1 |
| 1-3 | 0.5 |
| 4-8 | 0.8 |
| >8 | 1 |

The system 100 provides alerts in response to predetermined events (e.g., school evacuation, school sporting event cancelled) to one guardian identified from the one or more authorized guardians based on electronic calendars associated with the authorized guardian, pre-stored settings, and the type of the predetermined events. The alerts may be sent using many methods of communication, including email Short Message Service (SMS), phone, pager, or any other communications technique as would be understood by one of ordinary skill in the art.

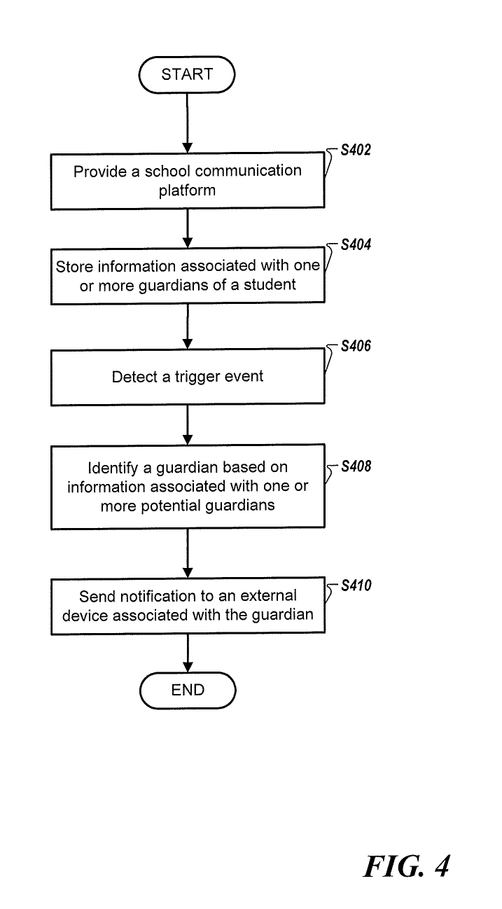

FIG. 4 is a flowchart that shows a method for communicating educational information according to one example. At step S402, the server 102 may provide a school communication platform. The school communication platform may be used to input information associated with the students. An administrator may input information associated with one or more guardians associated with a student. At step S404, the information associated with the one or more guardians are stored in the guardian database 206.

At step S406, the server 102 may detect a trigger event. The trigger event may be any event associated with outputting a notification to one or more guardians associated with the student. The trigger event may include emergency events (e.g., school evacuation, weather, sickness), school sporting event cancellation, grade notification (e.g., new grade posted, compliance notification (e.g., reading assignment, homework), student rank generation, and the like.

At step S408, the server 102 identifies, in real time, at least one guardian as a function of a plurality of factors. The plurality of factors may include electronic calendars associated with the authorized guardians, predefined settings, and the type of the trigger event. A guardian may be associated with each trigger event. For example, emergency notifications may be associated with a first guardian while compliance notification may be associated with a second guardian. The server 102 may reference the guardian database 206 to determine the guardian associated with the trigger event.

Further, the server 102 may retrieve information from one or more electronic calendars from the user device 106 of the guardian associated with the trigger event to determine whether the guardian is available to receive the notification. The server 102 may access the electronic calendar from the user device 106 of the guardian based on the calendar access information stored in the guardian database 206. One or more electronic calendars (e.g. work, personnel) may be associated with each guardian. The calendar information may include any entries in the electronic calendar, such as appointments, meetings vacation, or other scheduling information. Thus, the server 102 may analyze the information to determine whether the guardian is available. For example, if the calendar entry indicates “vacation”, the server 102 may determine that the guardian is not available. Further, when the guardian is not available and the trigger event is an emergency event, the server 102 may identify a secondary guardian to notify.

At step S410, the server 102 outputs a notification to the user device of the identified guardian at step S408. The system may automatically notify the identified guardian. For example, the system may generate an e-mail, an automated telephone message, or a text message to the identified guardian, letting the identified guardian know about the occurrence of the trigger event. For example, if a student had to submit an assignment by 9 a.m. and has failed to do so by 9 a.m., the server 102 may generate an e-mail to the identified guardian, letting the identified guardian know that the student is late on the homework assignment.

The system generates alerts based on the student's performance (e.g., grades, attendance) and provides the alerts to one or more communications devices associated with one or more authorized users (e.g., person responsible for the student). The alert type is based on the trigger event.

The alert type may be based on the student performance. A first alert may be to the parent by email, a second alert may be a prerecorded voice message, and the like. Further, the second alert may be transmitted to another user device associated with a secondary guardian.

FIG. 5 is a flowchart for generating a student ranking according to one example. The student ranking generation may be triggered at step S406. The student ranking may be generated at predetermined times (e.g., each day, each month) or may be triggered based on an event (e.g., availability of new test scores, receiving a request from a guardian, teacher, or administrator).

At step S502, the server 102 may receive a request to generate a student rank associated with one or more students. A teacher may generate the ranking for a whole class. A parent may generate the ranking of a student with respect to other classmates. An employer may generate the ranking of the student with respect to other students in a given geographical area.

At step S504, the server 102 generates the rank. The server 102 may determine the ranking of a student based on a weighted formula that includes a plurality of parameters such as the parameters shown in FIG. 3.

The weighted formula may be expressed as:

$$Rank = {\sum }_{i = 1}^{n} {parameter}_{i} \times {weight}_{i} \qquad ( 1 )$$

where n is the number of parameters.

The parameters can include various weights corresponding to the importance of the parameter as predetermined by the teacher, the administrator, or the like. For example, an employer may use higher weights for the parameters associated with the potential job for the student. The rank may be stored in the educational database 110. The weights may be input via the school communication platform.

The weights may also be automatically determined by the server 102. For example, the weights may be automatically determined as a function of an objective. The objective may be a particular job performance, starting salary, and/or university acceptance. For example, for each objective, the server 102 may track the parameters' value and a level of success associated with the objective to determine which parameters have a bigger impact on the level of success. Then, the server 102 may modify the weights of the parameters based on the tracking. For example, the server 102, based on the tracking, may determine that there is a high correlation between grades 300 and university acceptance. Thus, the server 102 may associate a higher weight for the grade parameter when the objective is university acceptance.

At step S506, the server 102 may output the ranking to the user device 106 of the authorized user. Further, the server 102 may output a notification indicating a new (e.g., updated) student ranking to a user device 106 associated with the student. In addition, the server 102 may output the alert to the user device 106 of the identified guardian indicating that the student rank is requested. The notification may include information associated with the requester (e.g., identity, contact information). For example, when a ranking is generated for student A, the server 102 may retrieve from the student database 200 a preferable contact method associated with the user. Then, the server 102 may output an alert to the user device associated with student A via the preferable contact method (e.g., email, text, voice message).

Further, the server 102 may limit information with the ranking based on the level of access associated with the guardian and stored in the guardian database 206. For example, the information may include the student rank and each of the parameter values when the guardian has unlimited access to the student record. In another example, the information may only include the rank when the guardian has a limited access to the student record.

At step S508, the server 102 may check whether the user rank is below a predetermined threshold (e.g., below 25 percentile). In response to determining that the student rank is below the predetermined threshold, the process proceeds to step S510. In response to determining that the student rank is not below a predetermined threshold, the process ends. At step S510, the server 102 may output a notification to the guardian of the student indicating that the student rank is below the predetermined threshold.

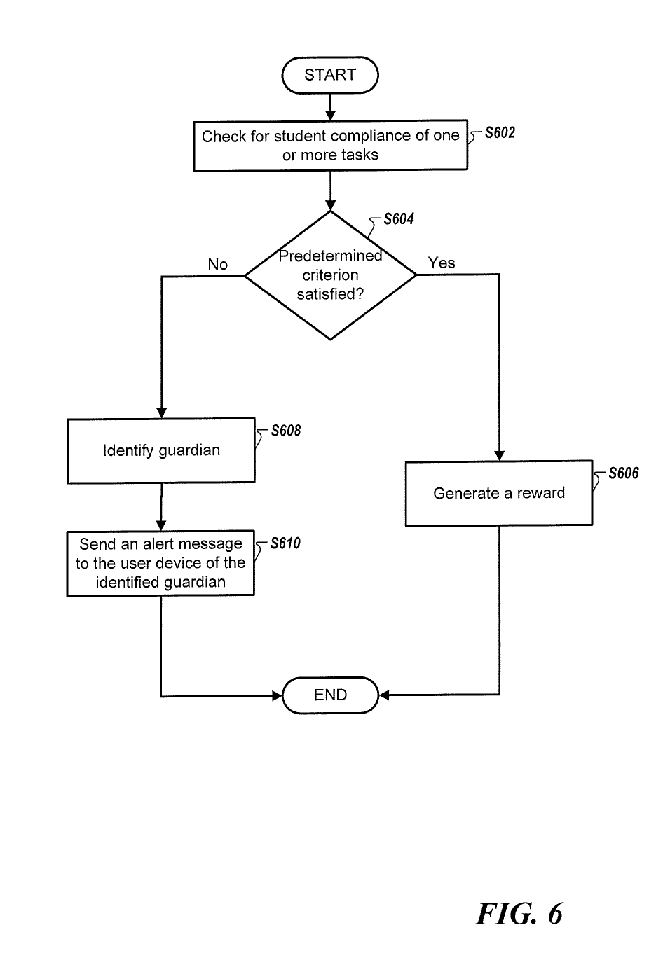

FIG. 6 is a flowchart that shows a method for student compliance according to one example. Student compliance may be triggered at step S406 of the method shown in FIG. 4. The server 102 may further determine student compliance. For example, the system 100 may be used to check whether the student has satisfied a predetermined criterion (e.g., achieve a predetermined rank, complete an assignment or other predefined task).

In one example, the predetermined criterion may be a number of pages read by the student. For example, the student may have to read a predetermined number of pages every period. The period may be a week, a month, or other suitable period configured by the parent, teacher, or administrator.

At step S602, the server 102 may check for student compliance of one or more tasks associated with the student at predefined periods and/or times. For example, the server 102 may check every night at a predefined time. The predefined periods and/or predetermined times may be associated with predetermined criteria. For example, the server 102 may check for compliance with school assignment every day. The server 102 may check for reading compliance every week.

At step S604, the server 102 may determine whether the predetermined criterion associated with one or more of the tasks is satisfied. For example, once the predetermined period has passed, the server 102 determines the number of page read. This may be done by checking a log stored in the memory 1502. The server 104 may update the log by accessing an external e-reader associated with the student. Further, the server 104 may collect data from a third party application (e.g., e-reader viewer) running on the user device 106 of the student. Further, in one example, an authorized user may input the number of page read when the student is reading a physical book. In response to determining that the user has satisfied the predetermined criterion, the server 102 may generate a reward to the student, at step S606. In response to determining that the student has not satisfied the predetermined criteria, the process proceeds to step S608.

At step S608, the server 102 identifies one or more guardians associated with the student. At step S610, the server 102 generates and outputs a notification to the user devices 106 of the one or more identified guardians indicating that the student did not satisfy the predetermined criterion. Further, the server 102 may transmit a signal to lock (disable) games or other applications on the user device 106 associated with the student. The server 102 may also transmit a signal to lock (disable) other devices associated with the student (e.g., a game console).

The reward generated, by the server 102, may use a point system. That is, the student collects points. For example, each time the reward is generated a predefined number of points may be added to a total number of points associated with the student. The total number of points may be stored in the memory of the user device 106 and/or in the memory of the server 102. The predefined number of points may be a function of the performance of the student. For example, the server 102 may check to see how many books above the threshold the user 104 has read. For each book read above the threshold, the student may be given additional points. The points may be then redeemed for gift certificates, cash, discounts, and the like.

In one embodiment, the student may decide on a reward preference for each reward generated. That is, the server 102 may output a list of available rewards. The student may then select a reward from the list of available rewards. The reward system may also include levels. That is, once the student collects a predetermined number of points then the student is associated with a level such as gold member, silver member or the like. Each of the member level may have a number of benefits and advantages associated with it. The student may need to maintain a level of performance to maintain the membership level. In one embodiment, the reward may also be posted on the user social media accounts such as Facebook. For example, once the user reach a reward level, the server 102 may post the reward level on the user social media account. The reward system may also include unlocking badges for performing an activity. That is, the student may unlock “an international badge” for reading books in a set of languages. “A daily badge” may be unlocked for reading a book every day. Other types of badges may be available as would be understood by one of ordinary skill in the art.

The reward may be an encouragement signal (e.g., indicator). The encouragement signal may be a function of the age, gender, and preference of the student. For example, in response to determining that the student is a child (e.g., Pre-school), the system may play a song to the student.

The server 102 may output an alert message to a user device associated with a guardian of the student indicating that the student has satisfied the predetermined criterion (e.g., completed assignments, read a predetermined number of books, participated in a predetermined number of extracurricular activities).

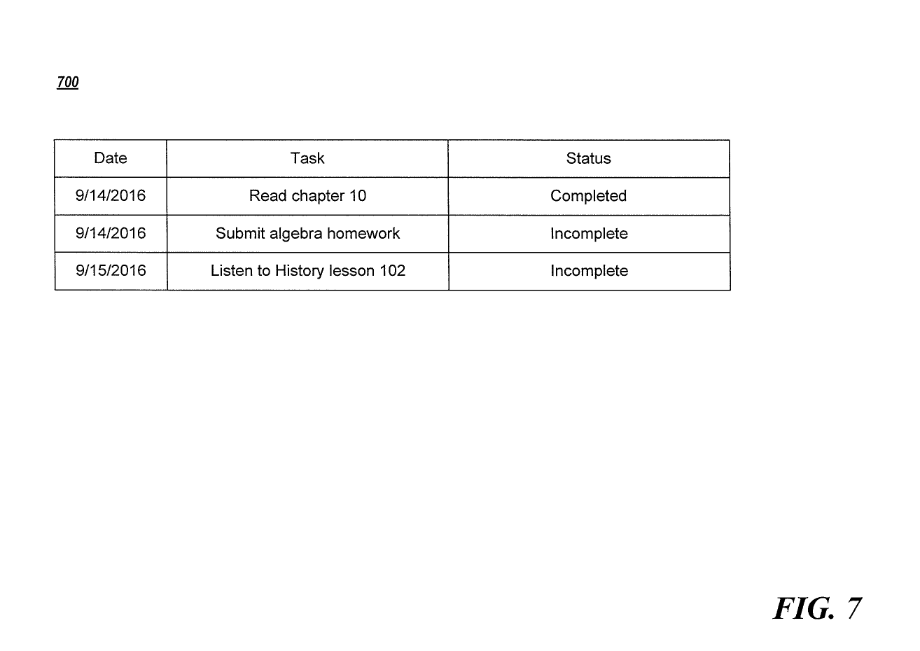

FIG. 7 is an exemplary log stored by the system according to one example. The log stores information associated with a student task. The log 700 may be stored in the memory 1502. The log 700, may include one or more of, but not limited to, a date, an assignment, and a status. The status may be completed, in progress, not started, or the like. The server 102 may check the log 700 to determine whether the student has satisfied a predetermined criterion, for example, at step S602 of FIG. 6.

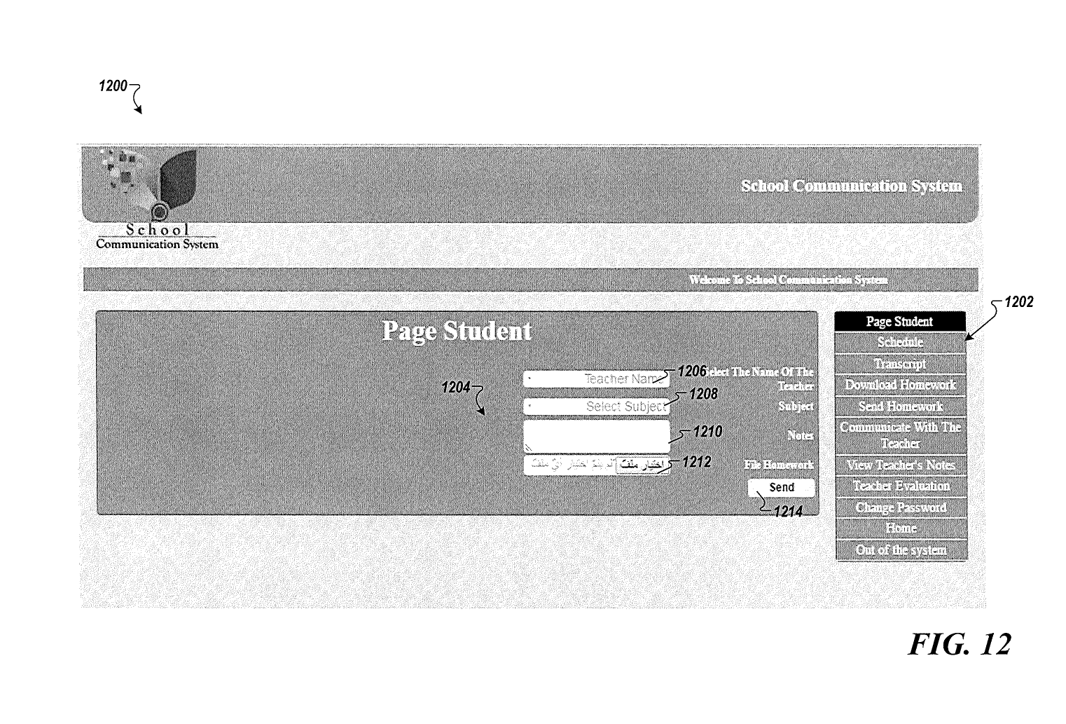

The server 102 may determine the status based on the category of the student task. The server 102 may update the status based on information received from a student interface (e.g., student interface 1200 shown in FIG. 12). For example, the server 102 may update the status to “completed” upon receiving a student homework submission when the task is an assignment. The server 102 may also track student activities on the user interface. For example, the server 102 may detect whether the student has clicked on a particular link (e.g., link to listen or to watch a particular lecture). The server 102 may proceed to update the status once the student has clicked on the particular link. The server 102 may also validate that the student is listening/watching by providing random check messages to the student where the student has to click “ok” to validate that the student is indeed listening/watching the particular lecture associated with the task.

In addition, the student may submit a reading/listening status via the student interface. The student submission may be validated by a guardian. For example, once the student submits the reading status, the guardian is notified. At this point, the server 102 may request from the guardian, via the school communication platform or by sending a wireless alert to the guardian (i.e., email, text, etc.), authentication before proceeding to update the reading status in the user log. The guardian can authenticate by entering a special pin code not known to the student to validate that the reading/listening status submitted by the student. Once the authentication information has been received by the server 102, the CPU 1500 proceeds to update the status of the reading/listening task based on what the student has entered or based on what information the guardian entered or a combination thereof.

The server 102 may also update the status based on information received from external device (e.g., audio player, electronic reader). The server may poll one or more electronic readers associated with the student to determine the reading status. For example, server 102 may obtain information about the reading statistics (e.g., percentage of the read and remaining pages in a book).

The memory 1502 of the server 102 includes one or more specialized registers that may be used additionally or alternatively to the log. An attribute vector characterizing attributes of a student may be stored in a first register. For example, parameters values associated with each task for each student can make up the entries of the attribute vector, which may be stored in the first register. For example, each entry of the attribute vector for a student can correspond to amounts of time the student has spent on each assigned task. The first register can be updated periodically or in real-time upon receiving information from a user device 106 of a student (e.g., student submits an assignment). In addition, thresholds of tasks associated with students may be stored in a second register in the memory 1502 of the server 102. In addition, the server 102 may compare values stored in the first register with the thresholds stored in the second register to determine a compliance status. For example, the server 102 may access and compare the values at step S602 of FIG. 6. In response to determining that one or more parameter values does not exceed the thresholds, the server 102 outputs an alert message to the user device associated with the guardian indicating that the student has not satisfied the predetermined criterion associated with a student task. In one example, the server 102 may output a second alert message to the user device of the guardian indicating that the student has satisfied the predetermined criterion associated with the student task when one or more parameter values exceed the thresholds. Further, the server 102 may generate a reward to the student as described previously herein (e.g., at step S606) when the one or more parameter values exceeds the thresholds. In addition, the server 102 may transmit a signal to lock one or more entertainment devices associated with the student when the one or more parameters values does not exceed the thresholds. A third register may store the weights of the parameters used, for example, to calculate the student rank.

The system 100 includes a plurality of interfaces. The interfaces describe a template for communication school information via an e-platform at a remote device, such as user device 106. The user interfaces are part of a website, web portal, personal computer application, or mobile device application configured to allow a user to interact with the server 102. The user interfaces may be implemented using any local or distributed text or graphical user interface technologies. For example, the interfaces may be accessible via networks such as the internet through the use of a web server. Web server interfaces are implemented using documents (e.g., HTML, XML) provided by applications such as Apache™ Web server and Microsoft™ Internet Information Services (IIS). In one example, a user interface may include a section to present indication of communication messages to the user (e.g., alerts, notifications, emails). The user interface may also include another section to present icons to the user. The icons may be selectable to navigate between various user interfaces associated with each operation available to the user. Described herein are exemplary user interfaces.

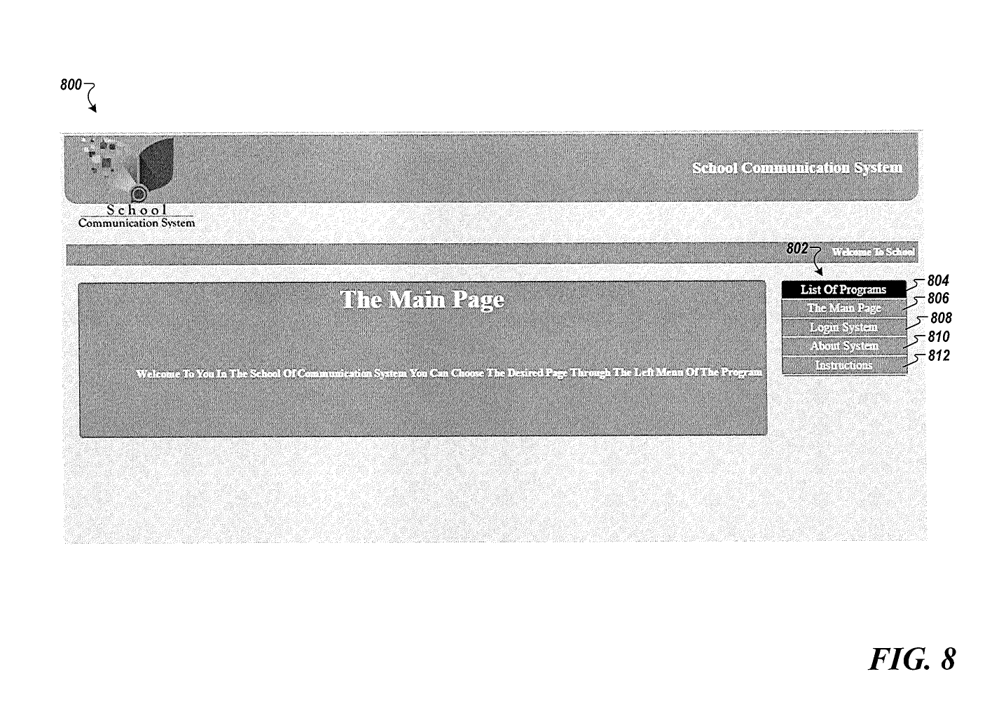

FIG. 8 is a schematic that shows a UI 800 according to one example. A “Navigation” pane 802 presents the user with five navigational controls for accessing a plurality of user interfaces associated with available operations. A first navigational control 804, when selected, presents the user a list of available operations. A second navigational control 806, when selected, presents the user with the “Home” UI. A third navigational control 808, when selected, presents the user with a “login” UI (e.g., interface 900). A fourth navigational control 810, when selected, presents the user with information about the system 100. A fifth navigational control 812, when selected, presents the user with instructions for using the system 100.

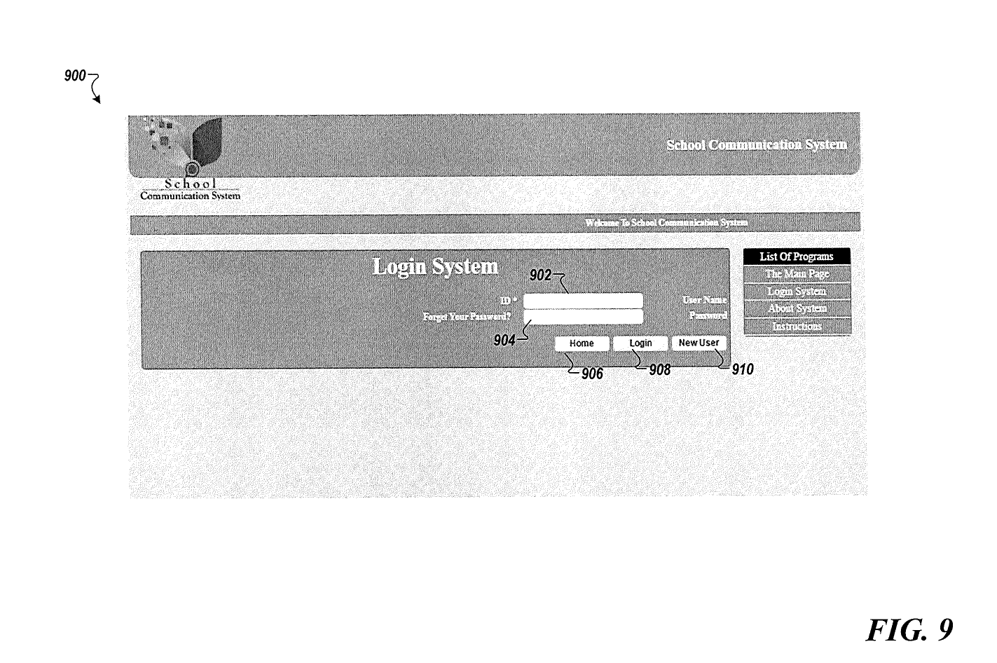

FIG. 9 is a schematic that shows a “login” UI 900 according to one example. The login interface 900 provides initial access to the users for performing system operations. Some of the operations of the system 100 are limited to authenticated and authorized users. Upon activation of the “Home” button 906, for example, the user may be presented with the “Home” UI 900. Upon activation of the “Login” button 908, the system may check to see whether the username and password inputted by the user matches a username-password association stored in the memory. Upon activation of the “New user” button 910, the system may prompt the user to enter personal information to register to the system 100. Upon authentication of the user, the system 100 presents the user with UI associated with the category of the user (e.g., student, guardian, teacher, and administrator).

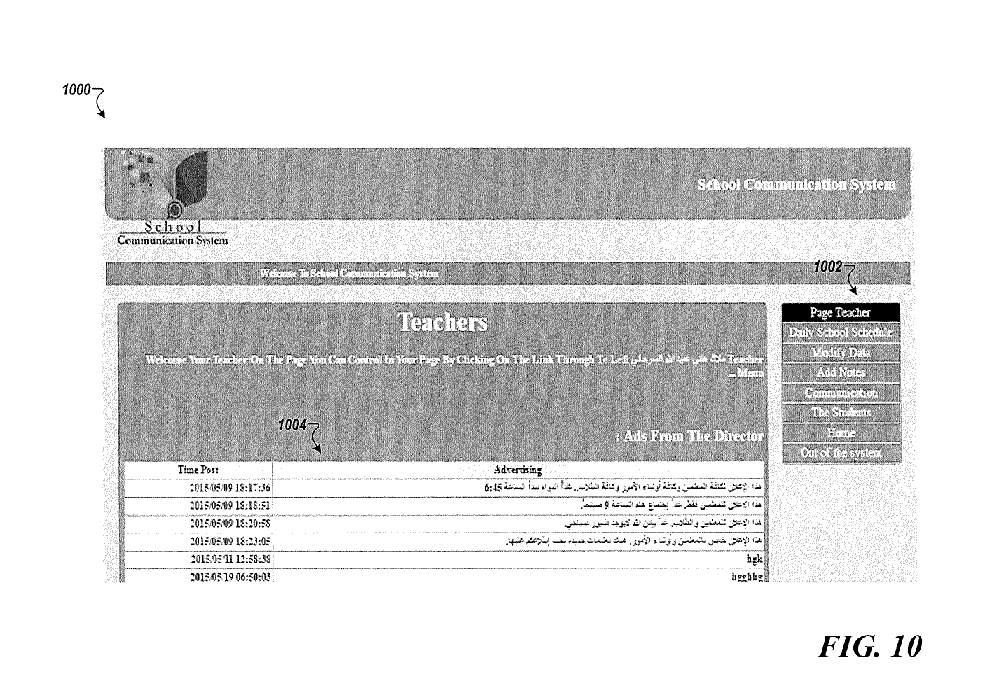

FIG. 10 is a schematic that shows a “teacher” UI 1000 according to one example. A “Teacher navigation” pane 1002 presents the teacher with navigational controls for accessing various operations associated with the teacher. The operations may include updating a daily school schedule, adding notes for students, communicating with guardians and students, and generating and viewing student records. A “message” pane 1004 shows the teacher's inbox. Upon clicking on a message title, the system displays the message summary.

FIG. 11 is a schematic that shows a “Guardian” UI 1100 according to one example. A “Guardian navigation” pane 1102 presents the guardian with navigational controls for accessing various operations associated with the guardian. The operations may include, but are not limited to, communicating with the teacher, generating a transcript, viewing the daily school schedule, and viewing teachers' notes. A “Guardian message” pane 1104 shows the guardian's inbox. Upon clicking on a message title, the system 100 displays the message summary.

FIG. 12 is a schematic that shows a “student” UI 1200 according to one example. A “Student navigation” pane 1202 presents the student with navigational controls for accessing various operations associated with the student. The operations may include, but are not limited to, viewing a schedule, viewing a transcript, downloading a homework, submitting a homework, communicating with the teacher, viewing a teacher's notes, and submitting a teacher evaluation. A “Submit homework” field 1204 provides the student with control fields to submit an assignment. A first field 1206 is for inputting a teacher name. A second field 1208 is for inputting a homework subject. A third field 1210 is for inputting notes to the teacher. A fourth field 1212 presents the student with a search box, a drop-down menu, or other selection control for selecting the computer file of the homework. Upon activating the “send” button 1214, the computer file is transmitted to the teacher. Further, the CPU 1500 may update the log associated with the student.

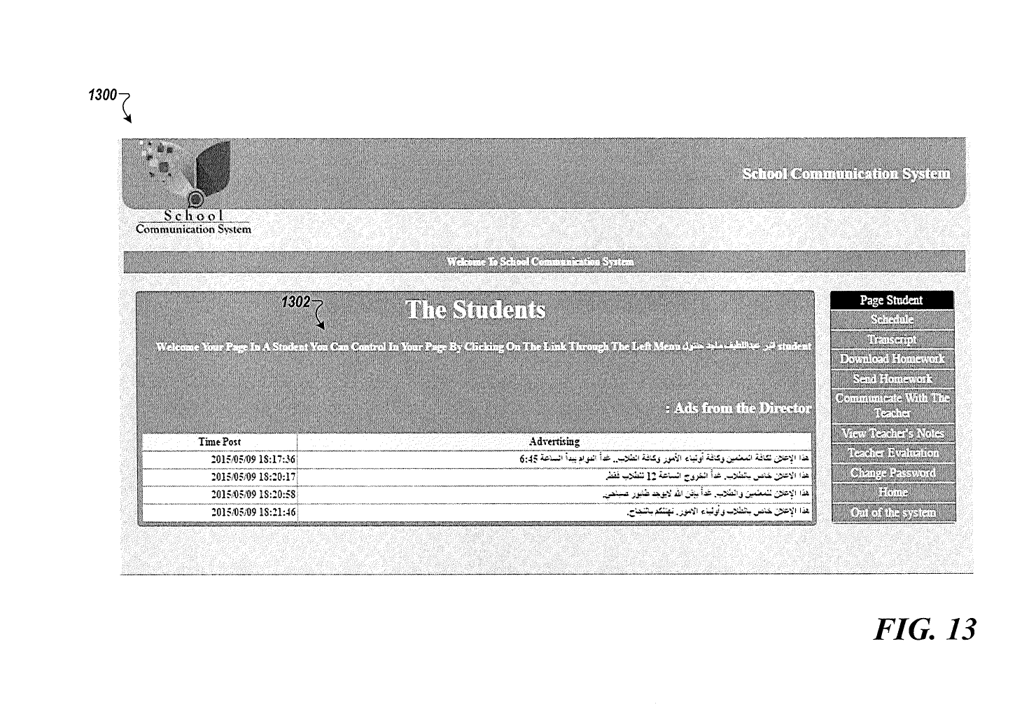

FIG. 13 is a schematic that shows an exemplary “Student” UI 1300 according to one example. A “Student message” pane 1302 shows the student's inbox. Upon clicking on a message title, the system 100 displays the message summary.

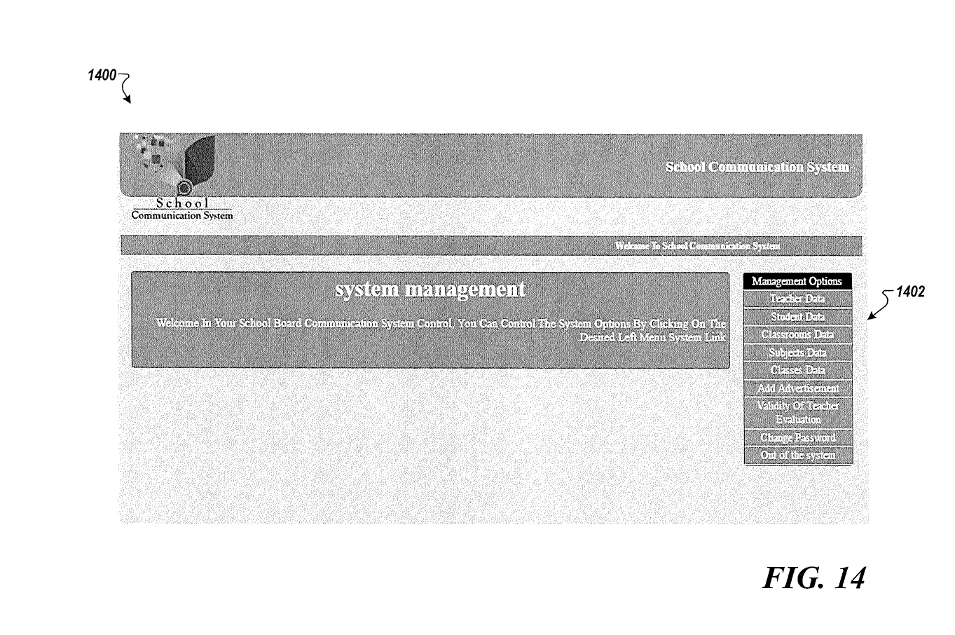

FIG. 14 is a schematic that shows an “Administrator” UI 1400 according to one example. An “Administrator navigation” pane 1402 presents the administrator with navigational controls for accessing various operations associated with the administrator. The operations may include, but are not limited to, updating teachers information, updating guardians information, updating students information, updating subjects information, updating classes information, sending messages to students, guardians, and teachers, and validating teacher evaluations.

Next, a hardware description of the server 102 according to exemplary embodiments is described with reference to FIG. 15. In FIG. 15, the server 102 includes a CPU 1500 which performs the processes described herein. The process data and instructions may be stored in memory 1502. These processes and instructions may also be stored on a storage medium disk 1504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 102 communicates, such as user devices.

Further, the claimed advancements may be provided as a utility application, background daemon, or component of an operating system, or combination thereof, executing in conjunction with CPU 1500 and an operating system such as Microsoft Windows 7, UNIX, Solaris, LINUX, Apple MAC-OS and other systems known to those skilled in the art.

In order to achieve the server 102, the hardware elements may be realized by various circuitry elements, known to those skilled in the art. For example, CPU 1500 may be a Xenon or Core processor from Intel of America or an Opteron processor from AMD of America, or may be other processor types that would be recognized by one of ordinary skill in the art. Alternatively, the CPU 1500 may be implemented on an FPGA, ASIC, PLD or using discrete logic circuits, as one of ordinary skill in the art would recognize. Further, CPU 1500 may be implemented as multiple processors cooperatively working in parallel to perform the instructions of the inventive processes described above.

The server 102 in FIG. 15 also includes a network controller 1506, such as an Intel Ethernet PRO network interface card from Intel Corporation of America, for interfacing with network 104. As can be appreciated, the network 104 can be a public network, such as the Internet, or a private network such as LAN or WAN network, or any combination thereof and can also include PSTN or ISDN sub-networks. The network 104 can also be wired, such as an Ethernet network, or can be wireless such as a cellular network including EDGE, 3G and 4G wireless cellular systems. The wireless network can also be WiFi, Bluetooth, or any other wireless form of communication that is known.

The server 102 further includes a display controller 1508, such as a NVIDIA GeForce GTX or Quadro graphics adaptor from NVIDIA Corporation of America for interfacing with display 1510, such as a Hewlett Packard HPL2445w LCD monitor. A general purpose I/O interface 1512 interfaces with a keyboard and/or mouse 1514 as well as an optional touch screen panel 1516 on or separate from display 1510. General purpose I/O interface also connects to a variety of peripherals 1518 including printers and scanners, such as an OfficeJet or DeskJet from Hewlett Packard.

A sound controller 1520 is also provided in the server 102, such as Sound Blaster X-Fi Titanium from Creative, to interface with speakers/microphone 1522 thereby providing sounds and/or music.

The general purpose storage controller 1524 connects the storage medium disk 1504 with communication bus 1526, which may be an ISA, EISA, VESA, PCI, or similar, for interconnecting all of the components of the server 102. A description of the general features and functionality of the display 1510, keyboard and/or mouse 1514, as well as the display controller 1508, storage controller 1524, network controller 1506, sound controller 1520, and general purpose I/O interface 1512 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in the circuitry on a single chipset.

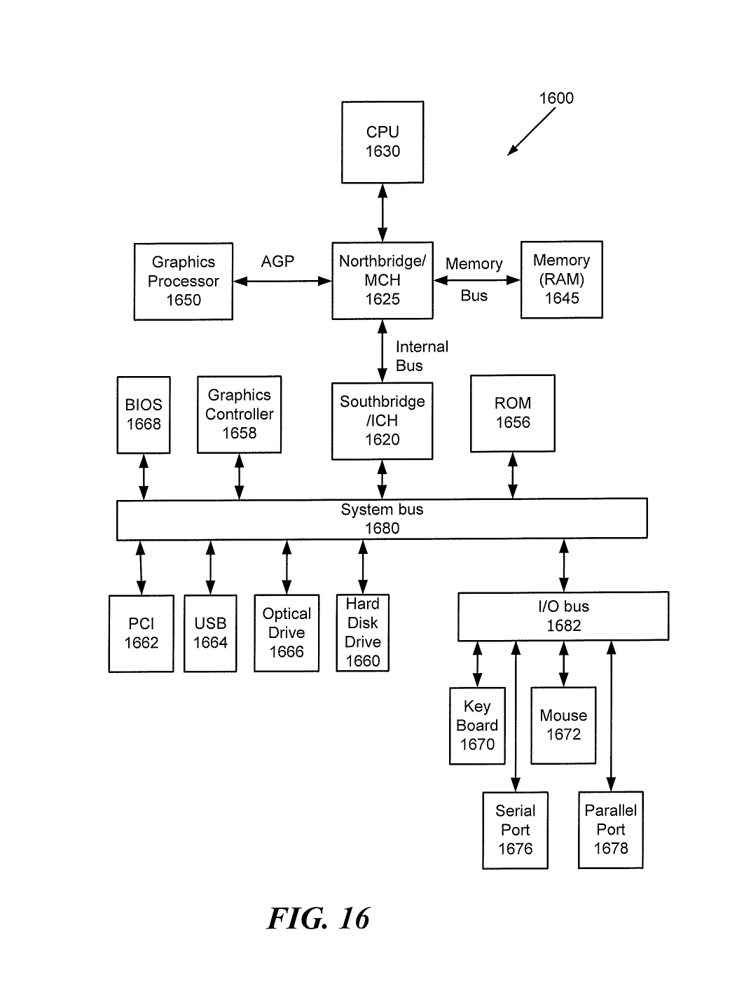

FIG. 16 shows a schematic diagram of a data processing system, according to certain embodiments, for communicating school information utilizing the methodologies described herein. The data processing system is an example of a computer in which specific code or instructions implementing the processes of the illustrative embodiments may be located to create a particular machine for implementing the above-noted process.

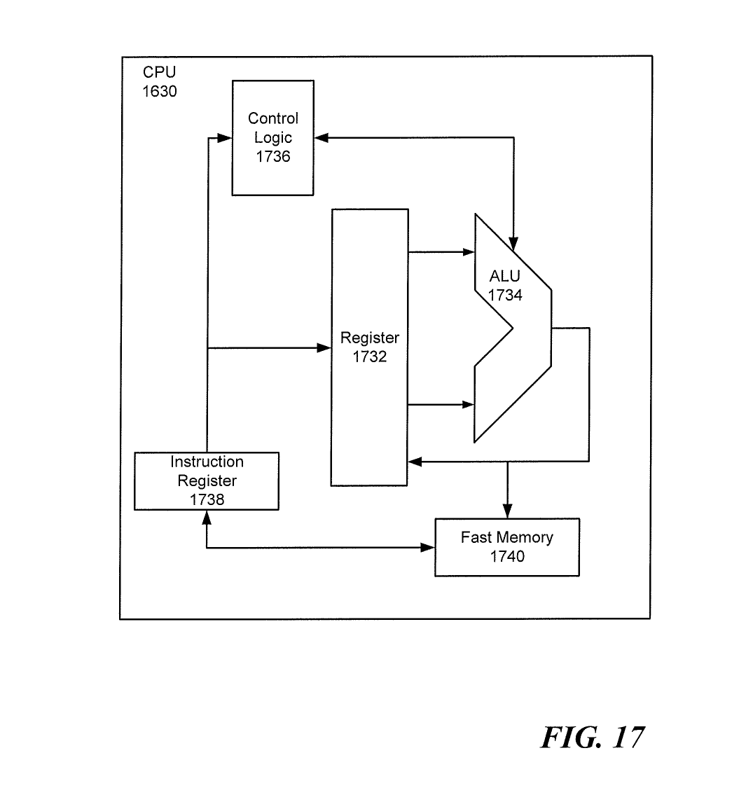

In FIG. 16, data processing system 1600 employs a hub architecture including a north bridge and memory controller hub (NB/MCH) 1625 and a south bridge and input/output (I/O) controller hub (SB/ICH) 1620. The central processing unit (CPU) 1630 is connected to NB/MCH 1625. The NB/MCH 1625 also connects to the memory 1645 via a memory bus, and connects to the graphics processor 1650 via an accelerated graphics port (AGP). The NB/MCH 1625 also connects to the SB/ICH 1620 via an internal bus (e.g., a unified media interface or a direct media interface). The CPU 1630 may contain one or more processors and may even be implemented using one or more heterogeneous processor systems. For example, FIG. 17 shows one implementation of CPU 1630.

Further, in the data processing system 1600 of FIG. 16, SB/ICH 1620 is coupled through a system bus 1680 to an I/O Bus 1682, a read only memory (ROM) 1656, an universal serial bus (USB) port 1664, a flash binary input/output system (BIOS) 1668, and a graphics controller 1658. In one implementation, the I/O bus can include a super I/O (SIO) device.

PCI/PCIe devices can also be coupled to SB/ICH 1620 through a PCI bus 1662. The PCI devices may include, for example, Ethernet adapters, add-in cards, and PC cards for notebook computers. Further, the hard disk drive (HDD) 1660 and optical drive 1666 can also be coupled to the SB/ICH 1620 through the system bus 1680. The Hard disk drive 1660 and the optical drive or CD-ROM 1666 can use, for example, an integrated drive electronics (IDE) or serial advanced technology attachment (SATA) interface.

In one implementation, a keyboard 1670, a mouse 1672, a serial port 1676, and a parallel port 1678 can be connected to the system bus 1680 through the I/O bus 1682. Other peripherals and devices that can be connected to the SB/ICH 1620 include a mass storage controller such as SATA or PATA (Parallel Advanced Technology Attachment), an Ethernet port, an ISA bus, a LPC bridge, SMBus, a DMA controller, and an Audio Codec (not shown).

In one implementation of CPU 1630, the instruction register 1738 retrieves instructions from the fast memory 1740. At least part of these instructions are fetched from the instruction register 1738 by the control logic 1736 and interpreted according to the instruction set architecture of the CPU 1630. Part of the instructions can also be directed to the register 1732. In one implementation, the instructions are decoded according to a hardwired method, and in another implementation, the instructions are decoded according a microprogram that translates instructions into sets of CPU configuration signals that are applied sequentially over multiple clock pulses. After fetching and decoding the instructions, the instructions are executed using the arithmetic logic unit (ALU) 1734 that loads values from the register 1732 and performs logical and mathematical operations on the loaded values according to the instructions. The results from these operations can be feedback into the register and/or stored in the fast memory 1740. According to certain implementations, the instruction set architecture of the CPU 1630 can use a reduced instruction set architecture, a complex instruction set architecture, a vector processor architecture, a very large instruction word architecture. Furthermore, the CPU 1630 can be based on the Von Neuman model or the Harvard model. The CPU 1630 can be a digital signal processor, an FPGA, an ASIC, a PLA, a PLD, or a CPLD. Further, the CPU 1630 can be an x86 processor by Intel or by AMD; an ARM processor, a Power architecture processor by, e.g., IBM; a SPARC architecture processor by Sun Microsystems or by Oracle; or other known CPU architecture.

The present disclosure is not limited to the specific circuit elements described herein, nor is the present disclosure limited to the specific sizing and classification of these elements. The functions and features described herein may also be executed by various distributed components of a system. For example, one or more processors may execute these system functions, wherein the processors are distributed across multiple components communicating in a network. The distributed components may include one or more client and server machines, which may share processing in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

The hardware description above, exemplified by any one of the structure examples shown in FIG. 15 or 16, constitutes or includes specialized corresponding structure that is programmed or configured to perform the algorithms shown in FIGS. 3, 4, 5, and 6.

A system which includes the features in the foregoing description provides numerous advantages to users. In particular, the system automatically identifies one or more guardians based on the availability and the notification category. A computer selected guardian provides the advantage of expedited and better identification based on the large amount of data which could not be feasibly done by a human. In addition, generating and transmitting alerts to the guardian provide expedited results (e.g., timely interference from the guardian). Therefore, previously existing problem of guardians not being notified in time of potential serious or life-threatening events can be overcome by providing immediate notifications. This could also result in obtaining information from a guardian that could provide life-saving information. Therefore, the technical solution to the technical problem of adequately updating real-time status information which solves a variety of problems is described herein. Further, the system automatically updates weights of parameters to determine a rank as a function of an objective. This provides an accurate ranking for the specific objective, which cannot be feasibly done by a human. Thus, the system and associated methodology described herein amount to significantly more than an abstract idea based on the improvements and advantages described herein.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

The above disclosure also encompasses the embodiments listed below.

(1) A method for communicating educational information, the method including providing, via processing circuitry of a server, a school communication platform on a first external device, the processing circuitry including a first register configured to store an attribute vector characterizing a student; storing information associated with one or more guardians of the student acquired via the school communication platform; detecting, via the processing circuitry, whether a trigger event associated with the student has occurred based on one or more values of the stored attribute vector; identifying a first guardian from one or more guardians associated with the student as a function of the trigger event and the information associated with the one or more guardians when the trigger event is detected; and outputting a notification to an external device associated with the first guardian when the trigger event is detected, the notification including information associated with the trigger event.

(2) The method of feature (1), in which the trigger event includes an emergency event, a compliance notification, and a student rank generation.

(3) The method of feature (1) or (2), further including receiving a user request to generate a student rank via a second external device of a user; determining the student rank based on a plurality of parameters received via the school communication platform from the user; transmitting the student rank to the second external device; and outputting a notification to a third external device associated with the student and to the external device associated with the first guardian indicating that the student rank is requested.

(4) The method of feature (3), in which the step of determining the student rank includes applying

$$Rank = {\sum }_{i = 1}^{n} {parameter\_value}_{i} \times {weight}_{i}$$

where n is the number of parameters.

(5) The method of feature (4), in which the weight of each parameter is input by the user via the school communication platform.

(6) The method of any of features (1) to (5), in which the step of identifying the first guardian includes retrieving one or more electronic calendars associated with the one or more guardians; and identifying the first guardian based on information included in the one or more electronic calendars.

(7) The method of any of features (1) to (6), further including presenting on a display of the external device a user interface including a first section configurable to present an indication of communication messages to a user, and a second section configurable to present icons representing available operations associated with a category of the user, wherein at least some of the icons are selectable to present a second user interface associated with an operation.

(8) The method of any of features (1) to (7), further including analyzing a student record to determine a level of performance at preset time intervals; and generating a first alert message to the external device of the first guardian when the level of performance is below a predetermined value.

(9) The method of any of features (1) to (8), further including storing one or more thresholds associated with student tasks in a second register; comparing the attribute vector to the one or more thresholds to determine a compliance status; and outputting a first alert message to the external device when one or more attributes of the attribute vector does not exceed the one or more thresholds.

(10) The method of feature (9), further including generating a second alert message to the external device of the first guardian indicating that the student does satisfy a predetermined criterion when one or more attributes exceed one or more thresholds; and generating a reward to the student when one or more attributes of the attribute vector exceed one or more thresholds.

(11) The method of feature (10), in which the reward is a predefined number of points, the points being related to an account of the student.

(12) The method of feature (9), in which the reward is an encouragement indicator based on the age of the student.

(13) The method of feature (9), further including transmitting a signal to lock one or more entertainment devices associated with the student when one or more attributes does not exceed the one or more thresholds.

(14) A server for communicating educational information including a first register configured to store an attribute vector characterizing a student, and processing circuitry configured to provide a school communication platform to at least one external device; store information associated with one or more guardians of the student acquired via the school communication platform; detecting whether a trigger event associated with the student has occurred based on one or more values of the attribute vector; identify a first guardian from one or more guardians associated with the student as a function of the trigger event and the information associated with the one or more guardians when the trigger event is detected; and output a notification to an external device associated with the first guardian, the notification including information associated with the trigger event when the trigger event is detected.

(15) The server of feature (14), in which the trigger event includes an emergency event, a compliance notification, and a student rank generation.

(16) The server of feature (14) or (15), in which the processing circuitry is further configured to receive a user request to generate a student rank via a second external device of a user; determine the student rank based on a plurality of parameters received via the school communication platform from the user; transmit the student rank to the second external device; and output a notification to a third external device associated with the student and to the external device associated with the first guardian indicating that the student rank is requested.

(17) The server of feature (16), in which the processing circuitry is further configured to apply

$$Rank = {\sum }_{i = 1}^{n} {parameter\_value}_{i} \times {weight}_{i}$$

where n is the number of parameters.

(18) The server of feature (17), in which the weight of each parameter is input by the user via the school communication platform.

(19) The server of any of features (14) to (18), in which the processing circuitry is further configured to retrieve one or more electronic calendars associated with the one or more guardians; and identify the first guardian based on information included in the one or more electronic calendars.

(20) The server of any of features (14) to (19), in which the processing circuitry is further configured to present on a display of the external device a user interface including a first section configurable to present an indication of communication messages to a user, and a second section configurable to present icons representing available operations associated with a category of the user, in which at least some of the icons are selectable to present a second user interface associated with an operation.

(21) The server of any of features (14) to (20), in which the processing circuitry is further configured to analyze a student record to determine a level of performance at preset time intervals; and generate a first alert message to the external device of the first guardian when the level of performance is below a predetermined value.

(22) The server of any of features (14) to (21), in which the processing circuitry is further configured to store one or more thresholds associated with student tasks in a second register; compare the attribute vector to the one or more thresholds to determine a compliance status; and output a first alert message to the external device when one or more attributes of the attribute vector does not exceed the one or more thresholds.

(23) The server of feature (22), in which the processing circuitry is further configured to generate a second alert message to the external device of the first guardian indicating that the student does satisfy a predetermined criterion when one or more attributes exceed one or more thresholds; and generate a reward to the student when one or more attributes of the attribute vector exceed one or more thresholds.

(24) The server of feature (23), in which the reward is a predefined number of points, the points being related to an account of the student.

(25) The server of feature (22), in which the reward is an encouragement indicator based on the age of the student.

(26) The server of feature (22), in which the processing circuitry is further configured to transmit a signal to lock one or more entertainment devices associated with the student when one or more attributes does not exceed the one or more thresholds.

(27) A non-transitory computer readable medium storing instructions, which when executed by at least one processor cause the at least one processor to perform the method of any of features (1) to (13).

1. A method for communicating educational information, the method comprising:
providing, via processing circuitry of a server, a school communication platform on a first external device, the processing circuitry including a first register configured to store an attribute vector characterizing a student;
storing information associated with one or more guardians of the student acquired via the school communication platform;
detecting, via the processing circuitry, whether a trigger event associated with the student has occurred based on one or more values of the stored attribute vector;
identifying a first guardian from one or more guardians associated with the student as a function of the trigger event and the information associated with the one or more guardians when the trigger event is detected; and
outputting a notification to an external device associated with the first guardian when the trigger event is detected, the notification including information associated with the trigger event.

2. The method of claim 1, wherein the trigger event includes an emergency event, a compliance notification, and a student rank generation.

3. The method of claim 1, further comprising:
receiving a user request to generate a student rank via a second external device of a user;
determining the student rank based on a plurality of parameters received via the school communication platform from the user;
transmitting the student rank to the second external device; and
outputting a notification to a third external device associated with the student and to the external device associated with the first guardian indicating that the student rank is requested.

4. The method of claim 3, wherein the step of determining the student rank includes applying
$$Rank = {\sum }_{i = 1}^{n} {parameter\_value}_{i} \times {weight}_{i}$$
where n is the number of parameters.

5. The method of claim 4, wherein the weight of each parameter is input by the user via the school communication platform.

6. The method of claim 1, wherein the step of identifying the first guardian includes
retrieving one or more electronic calendars associated with the one or more guardians; and
identifying the first guardian based on information included in the one or more electronic calendars.

7. The method of claim 1, further comprising:
presenting on a display of the external device a user interface including
a first section configurable to present an indication of communication messages to a user, and
a second section configurable to present icons representing available operations associated with a category of the user, wherein at least some of the icons are selectable to present a second user interface associated with an operation.

8. The method of claim 1, further comprising:
analyzing a student record to determine a level of performance at preset time intervals; and
generating a first alert message to the external device of the first guardian when the level of performance is below a predetermined value.

9. The method of claim 1, further comprising:
storing one or more thresholds associated with student tasks in a second register;
comparing the attribute vector to the one or more thresholds to determine a compliance status; and
outputting a first alert message to the external device when one or more attributes of the attribute vector does not exceed the one or more thresholds.

10. The method of claim 9, further comprising:
generating a second alert message to the external device of the first guardian indicating that the student does satisfy a predetermined criterion when one or more attributes exceed one or more thresholds; and
generating a reward to the student when one or more attributes of the attribute vector exceed one or more thresholds.

11. The method of claim 10, wherein the reward is a predefined number of points, the points being related to an account of the student.

12. The method of claim 9, wherein the reward is an encouragement indicator based on the age of the student.

13. The method of claim 9, further comprising:
transmitting a signal to lock one or more entertainment devices associated with the student when one or more attributes does not exceed the one or more thresholds.

14. A server for communicating educational information comprising:
a first register configured to store an attribute vector characterizing a student; and
processing circuitry configured to
provide a school communication platform to at least one external device,
store information associated with one or more guardians of the student acquired via the school communication platform,
detect whether a trigger event associated with the student has occurred based on one or more values of the attribute vector,
identify a first guardian from one or more guardians associated with the student as a function of the trigger event and the information associated with the one or more guardians when the trigger event is detected, and
output a notification to an external device associated with the first guardian, the notification including information associated with the trigger event when the trigger event is detected.

15. The server of claim 14, wherein the trigger event includes an emergency event, a compliance notification, and a student rank generation.

16. The server of claim 14, wherein the processing circuitry is further configured to
receive a user request to generate a student rank via a second external device of a user,
determine the student rank based on a plurality of parameters received via the school communication platform from the user,
transmit the student rank to the second external device, and
output a notification to a third external device associated with the student and to the external device associated with the first guardian indicating that the student rank is requested.

17. The server of claim 16, wherein the processing circuitry is further configure to apply
$$Rank = {\sum }_{i = 1}^{n} {parameter\_value}_{i} \times {weight}_{i}$$
where n is the number of parameters.

18. The server of claim 17, wherein the weight of each parameter is input by the user via the school communication platform.

19. The server of claim 14, wherein the processing circuitry is further configured to present on a display of the external device a user interface including
a first section configurable to present indication of communication messages to a user; and
a second section configurable to present icons representing available operations associated with a category of the user, wherein at least some of the icons being selectable to present a second user interface associated with an operation.

20. A non-transitory computer readable medium storing computer-readable instructions therein which when executed by a computer cause the computer to perform a method for communicating educational information, the method comprising:
providing a school communication platform;
storing an attribute vector characterizing a student in a first register;
storing information associated with one or more guardians of the student acquired via the school communication platform;
detecting whether a trigger event associated with the student has occurred based on one or more values of the attribute vector;
identifying a first guardian from one or more guardians associated with the student as a function of the trigger event and the information associated with the one or more guardians when the trigger event is detected; and
outputting a notification to an external device associated with the first guardian, the notification including information associated with the trigger event when the trigger event is detected.
